(19) United States
(12) Patent Application Publication
(10) Pub. No.: US 2014/0282371 A1
(43) Pub. Date: Sep. 18, 2014

(54) SYSTEMS AND METHODS FOR CREATING OR UPDATING AN APPLICATION USING A PRE-EXISTING APPLICATION

(71) Applicant: MEDIA DIRECT, INC., Deerfield Beach, FL (US)

(72) Inventors: Scott HIRSCH, Boca Raton, FL (US); Sunny RAJPAL, Sunrise, FL (US)

(73) Assignee: Media Direct, Inc., Deerfield Beach, FL (US)

(21) Appl. No.: 13/831,125

(22) Filed: Mar. 14, 2013

(51) Int. Cl. G06F 9/44

(52) U.S. Cl. CPC G06F 8/36; G06F 8/65
USPC 717/106

(57) ABSTRACT

The disclosure herein relates to systems and methods for creating or updating applications using content from a pre-existing application, and in particular, utilizing content of a pre-existing application to create or update mobile applications and web applications including HTML 5 applications. An input may be received that identifies a pre-existing application to be utilized in creating or updating an application. One or more application modules may be derived from the content of the pre-existing application. The application content may be analyzed in accordance with a rule set to detect application features associated with the pre-existing application. The application features may be incorporated into the one or more application modules. The application modules may then be compiled into an application such as a mobile application or HTML 5 application.

### CROSS-REFERENCE TO RELATED APPLICATIONS

The present application is related to U.S. patent application No. ______ entitled “Systems and Methods for Creating or Updating an Application Using Website Content” (Docket No. 0343284.001) which is being filed concurrently with the present application, and which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present principles are directed to systems and methods for creating and updating applications, and more particularly, to systems and methods for creating and updating applications, or portions thereof, using content of a pre-existing application. In certain embodiments, the applications created or updated with the content of a pre-existing application may include mobile applications and web applications, including HTML 5 applications.

### BACKGROUND OF THE INVENTION

In modern times, businesses, organizations, governmental agencies and other entities often utilize computing applications to further their goals and objectives. For example, a single company may provide a mobile application for a smart phone, a television application for a smart television, an application for a device in a motor vehicle and possibly even a desktop application that can be installed on a desktop computer or laptop. The information and functionality provided by these various types of applications is often the same or similar to some extent. For example, each of the applications may advertise the company's goods and services, provide a contact form that permits an individual to transmit comments to the company, display a listing of products for purchase, provide a shopping cart which permits someone to add and remove goods to be purchased, or disseminate information on a particular topic.

Despite the overlap in content and functionality between the different applications, a company (or other entity) is typically faced with hiring separate developers to create the various types of applications. For example, a software development company specializing in mobile applications will be hired to create a mobile application for the company, while a software development company specializing in television applications will be hired to create a television application for the company. Consequently, developing a plurality of different applications can place a heavy financial burden on a company.

In addition, from the perspective of the software development companies, the creation of a single application can be an extremely complex and time-consuming task. In order to create an application, a programmer must have a certain level of technical knowledge (e.g., knowledge of programming languages and knowledge of particular hardware devices that execute the application). Moreover, even if a programmer has sufficient knowledge to create an application for one type of particular device (e.g., an iPhone™), it is often the case that the programmer does not possess sufficient knowledge to create applications for other types of devices (e.g., Android™ devices or for a particular type of television). Depending upon the complexity of the application, programmers can spend weeks, months or even years developing a single application.

Hence, there is a need for a software development platform that has the ability to generate one or more computing applications in an expedited, cost-effective manner that does not require technical knowledge.

### SUMMARY OF THE INVENTION

Systems and methods are provided for a platform that facilitates the generation of computing or software applications in an expedited, cost-effective manner. The applications created or updated with the content of a pre-existing application may include mobile applications and web applications, including HTML 5 applications. A software development platform may also permit users having little or no programming or technical knowledge to create various types of applications

The systems and methods disclosed herein may utilize content from a pre-existing application to create or update an application. An input may be received that identifies the pre-existing application to be utilized in creating or updating the application. In certain embodiments, the input may identify a pre-existing application that is accessible over a network (e.g., the Internet) or a pre-existing application that is stored locally on a personal computing device of a user. The pre-existing application may be retrieved over the network or may be uploaded from the personal computing device to a server.

The content of the pre-existing application may be analyzed in accordance with a rule set to detect application features associated with the application. This may include analyzing source code and files included in an archive file or application package. Exemplary application features that are detected within the application content may include content features (e.g., multimedia content, menus and hyperlinks), design features (e.g., alignment information, interface layouts and font information) and functional application (e.g., forms, photo galleries, shopping carts, RSS feeds, Atom feeds, event calendars, checkout pages, and product listings). Other types of application features may include features associated with permissions of an application (e.g. permission to utilize particular hardware features or permission to access data associated with an application or operating system). Any of the detected application features may then be incorporated into the one or more application modules for the application that is being created or updated.

In accordance with certain embodiments, systems and methods are disclosed for creating or updating a software application using content from a pre-existing application. The system includes a processor and a non-transitory computer readable storage medium. An application development platform may be provided that is adapted to assist a user with developing a first application using content of a pre-existing application and to receive an input from the user that identifies the pre-existing application. The application content of the identified pre-existing application may be analyzed in accordance with a rule set to detect application features associated with the pre-existing application and to determine one or more application modules that are to be created or updated for the first application. The rule set may include rules for detecting content features, functional features and design features of the pre-existing application. The detected application features may then be incorporated into the one or more application modules for the first application.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to similar or corresponding parts, and in which:

FIG. 1 is a block diagram of a system for creating or updating an application using content from a pre-existing application in accordance with certain embodiments.

FIG. 2 is a block diagram illustrating a detailed view of an application builder in accordance with certain embodiments.

FIGS. 3A-3C illustrate exemplary interfaces that may be provided by an application builder to create or update an application using content from a pre-existing application in accordance with certain embodiments.

FIG. 4 illustrates a mobile device which renders an interface of a pre-existing application that may be utilized to create the application module displayed in the simulation window of FIG. 3C in accordance with certain embodiments.

FIG. 5 is a flow chart illustrating a method for creating or updating an application using content from a pre-existing application in accordance with certain embodiments.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

In accordance with the principles described herein, a software development platform is provided for creating or updating an application, or portion thereof, using application content from a pre-existing application. In certain embodiments, the software development platform may be integrated with or may use the ones described in U.S. patent application Ser. No. 13/396,392 filed on Feb. 14, 2012 and U.S. patent application Ser. No. 13/396,368 (now, U.S. Pat. No. 8,261,231) filed on Feb. 14, 2012, both of which are herein incorporated by reference in their entirety. For example, the principles disclosed herein with respect to creating or updating applications using content from a pre-existing application may be incorporated as a feature of the software development platforms described in these references.

More specifically, in accordance with certain embodiments, a software development and distribution platform and corresponding arrangement may be provided that allows non-technical users and application developers to develop applications through the platform that may be built and compiled to run on multiple mobile operating systems and/or devices and utilize the various device and operating system specific features, without the need for programming knowledge or expertise. Certain of these embodiments allow users to highly customize the applications developed through the platform by selecting and combining various predefined components, features, application designs, and content and/or creating new components, such as app-types and modules. Certain embodiments allow users to deploy applications developed through the platform by submitting the compiled applications to digital distribution platforms associated with one or more types of operating systems and/or devices. Certain of these embodiments, allow the compilation to comprise an identifying reference and/or other basic information, rather than the application data itself, which may be used to retrieve application data from a remote source, and build and configure the application when end users download or execute the application. Certain embodiments allow users and developers to modify or update the applications and their content directly through the development platform.

Initially, a user may identify the pre-existing application that will be utilized to create or update an application. In certain embodiments, a user may specify a location on a network, such as an Internet protocol (IP) address or uniform resource locator (URL), that identifies a location of the pre-existing application, and the pre-existing application may be retrieved over the network. This may involve retrieving the pre-existing application from a digital distribution platform (e.g., the Android Market™ or Apple App Store™) that permits individuals to download and/or purchase the pre-existing application. A user may also identify a pre-existing application that resides on a personal computing device (e.g., desktop computer, laptop, tablet or smart phone) associated with the user that is developing the application. In some cases, the user may be permitted to upload the pre-existing application from the personal computing device to a server that processes the pre-existing application to create or update the second application.

The application content may be analyzed in order to detect application features within the application content. The application content may include, inter alia, source code, complied code, metadata files, manifest files, style sheets, multimedia files or other data associated with an application. Any type of file or data associated with an application may be analyzed to detect the presence of the application features.

In certain cases, an application (e.g., such as an Android™ application or iPhone™ application) may be comprised of an application package that is comprised of a plurality of files and directories. For example, an application package may include a manifest file that enumerates or lists all of the packaged files and directories that are included in an application package, a metadata file that includes various types of information (e.g., copyright information, genre of the application, the name of the application, release date, purchase date and access rights) about an application, source code files, files including the compiled data for an application, an image file that provides an icon that is to be associated with an application, a directory including multimedia resources that are utilized by the application, a directory including code that is specific to a particular processors (e.g., in the case that the application utilizes a virtual machine), and other types of files or directories. Any file, directory or data included in an application package may be utilized to detect application features in a pre-existing application.

However, the principles described herein are not limited to analyzing files that are included within an application package to detect application features of a pre-existing application. For example, in cases where the application is an HTML 5 application or web application, analyzing application content may include analyzing HTML, XHTML, XML or other types of similar files to detect the features of a pre-existing application. In particular, analyzing application content may include analyzing XML and HTML tags (e.g., <title> tags, <form> tags, <input> tags, <div> tags, <table> tags, <body> tags, <head> tags, <font> tags, or any other tag in any version of the HTML specification), attributes of the XML and HTML tags, and event triggers associated with the tags (e.g., associated with the onClick HTML event, on MouseOver HTML event or any other type of event).

In certain embodiments, a separate rule may be provided for analyzing the content for different application types. In other words, each type of application may be associated with a separate rule set that includes a set of rules for detecting application features for the particular type of application. For example, one rule set may be provided for detecting application features in an iPhone™ application, while a second rule set may be provided for detecting application features in an Android™ application. After determining the application type or format of a pre-existing application, an appropriate rule may be selected for detecting features of the pre-existing application. Each rule set may utilize a variety of different analysis tools (e.g., regular expressions and string querying functions) to scan the application content and to detect the application features of the pre-existing application.

The type of application features that may be detected can vary greatly. For example, a rule set may include rules for detecting multimedia data (e.g., text, images, videos, audio recordings, or other types of multimedia data) that is displayed or utilized by an application. The rule set may further include rules for detecting fonts utilized on the application, sizes of different interface elements (e.g., font size, image size, table size, or other size related information), alignment data (e.g., alignment of text, images and tables), hyperlinks (including hyperlinks associated with social networking or social media sites such as Facebook™, Twitter™ or LinkedIn™) and associated URLs. The rule set may also be utilized to detect more complex functional features that are provided by an application. For example, the application content may be analyzed to detect input forms, photo galleries, shopping carts, RSS feeds, Atom feeds, event calendars, checkout pages, product listings (e.g., included in an auction), contact lists, blogs, message boards, or any other functional feature that may be provided by an application.

After the application features have been detected, a user may be permitted to select the application features that are to be incorporated into an application, or portion of an application, that is being created or updated. In certain embodiments, the detected application features may be presented to the user on an interface and the user may be permitted to identify the application features that are to be included in the application by selecting/unselecting check boxes and/or other types of input elements (e.g., drop-down menus or radio buttons).

In certain embodiments, an application module may be created for a corresponding interface provided by a pre-existing application, and the application module may be populated with the application features that were detected on the interface or otherwise associated with the interface. An application module added to the application being developed (i.e., the application being created or updated) may serve to provide an interface for the application. For instance, if an interface providing a contact page (e.g., which includes contact information and a contact form for submitting comments) for a pre-existing application was analyzed, a corresponding application module may be added to the application being developed and the application features that were detected on the interface of the contact page (e.g., which includes the contact information and contact form) may be incorporated into the application module. When the application being developed is ultimately installed or executed on a target device of an end-user, the application module may provide an interface that includes the application features that were detected on the contact page interface provided by the pre-existing application.

In certain embodiments, an application module may be created for each interface (e.g., screen or page) that is provided by a pre-existing application. The interfaces may be identified in various ways and the manner in which the interfaces are identified may vary depending upon the application type of the pre-existing application. In some cases, the interfaces may be identified by traversing or crawling the internal links in the pre-existing application (e.g., links or buttons provided on a menu of the pre-existing application or provided within the text displayed on the pre-existing application). In other cases, the interfaces may be identified by analyzing particular files included in an application package (e.g., manifest files, metadata files or source code files). After the application modules are added to the application being developed, a user may customize the application being developed by specifying whether to include or exclude application modules from the application, or to include or exclude particular application features which are included in the application modules.

The manner in which the application features are incorporated into the application being created or updated may vary. In certain cases, the application features may be reproduced from an application and incorporated into the application that is being created or updated. For example, any multimedia data that is incorporated in an application may be reproduced or copied into the application being created. Other basic types of application features (e.g., titles, headings and fonts) can also be extracted and incorporated into the application in a relatively straightforward manner.

In other cases, preassembled modules may be added to applications in order to incorporate particular types of application features (e.g., input forms, photo galleries, event calendars and RSS feeds). For example, a preassembled module may be provided for incorporating an input form into an application. Thus, if an input form was detected on an interface provided by a pre-existing application which is being analyzed, then a preassembled module for providing an input form may be added to the application being created or updated. Once added, the preassembled module may automatically be customized or tailored to reflect the input form provided by the application being analyzed. For example, the input form may be customized to include the same input field names (e.g., name, address and email address) and input elements (e.g., check boxes, text fields and radio buttons) as the input form that was detected. Preassembled modules may be utilized to incorporate any application feature described herein.

In certain embodiments, the pre-existing application may initially be utilized to create or update a generic application. The generic application may represent an application having a standardized format that stores the features for the application in a uniform manner to facilitate conversion of the generic application into other types of native applications (e.g., applications for mobile devices such as an iPhone™ device, Android™ device or Blackberry™ device). Thus, after the generic application is generated using the application content of a pre-existing application, a user may specify that the generic application is to be converted or translated into a different application for a specific device (e.g., converted to an application that is compatible with a particular type of smart phone or smart television).

In certain embodiments, the generic application which is created or updated using the content of a pre-existing application may be represented and/or stored using the exemplary data model described in FIG. 4 (along with the corresponding description of this figure in the specification) of U.S. patent application Ser. No. 13/396,392 and U.S. patent application Ser. No. 13/396,368 (now, U.S. Pat. No. 8,261,231), both of which are incorporated by reference in their entirety.

For example, in utilizing such a data model, the application components, design elements, contents, settings, and other data utilized by developers to design, create, modify, and customize applications through the development platform and corresponding systems and methods described and illustrated herein may be organized and stored in a relational and/or hierarchical manner. In certain of these embodiments applications developed through the platform may include and/or be represented by a set of application components, content element, and/or design elements, each of which, in turn, may include, or be associated with, one or more other application components, content elements, and/or design elements and so on. For example, each application may be associated with an app-type, which includes one or more modules, each of which, in turn, includes one or more layouts and one or more features.

In certain embodiments, the application components, design elements, content elements, and other data, as well as their relationships to each other, may be represented and stored in a database, such as relational database. In certain other embodiments, these relationships and the application data may be represented and/or stored in any other suitable format and/or medium, such as in tables, trees, sets of links, or other similar structures. By storing this information in a relational manner, applications developed through the development and distribution platform can be easily stored, retrieved, built, and updated simply by representing each application through a series of relationships between the application's components, elements and other data. Moreover, this data model or architecture enables new application components, content elements, and design elements created or customized by developers or other third parties to be added to the development and deployment platform and used by developers in the development of future applications.

In other embodiments, the application being created or updated may represent an actual native application. For example, a pre-existing application created for an iPhone™ device may be utilized to create or update an application for an Android™ device. Like the pre-existing application, the application that is being created or updated may represent any type of application including a mobile application (e.g., an application for an Android™ device, iOS™ device or Windows Mobile™ device), a television application (e.g., an application for NetTV™, Google TV™ device or Apple TV™ device), a web application (e.g., an HTML 5 application or Facebook™ application), a motor vehicle application (e.g., an application that can be installed on a device in a car, train or plane), desktop application (e.g., that can be installed on a desktop computer or laptop), a kiosk application (e.g., an application that is installed on a kiosk device) or other type of application.

In certain embodiments, a user may specify the type of native application that is to be created or updated using the application content from a pre-existing application. For example, the user may be provided with a list of available application types that are specific to particular devices, operating systems and/or device platforms. The user may select the application type for the application that is being constructed. For example, the user may specify that the application being created is an application intended to be executed by a particular mobile device, desktop computer, television device, motor vehicle device, aircraft device, kiosk or other type of device. In some cases, the user may also be permitted to select additional design parameters associated with constructing the application such as the programming language that the application will be implemented in (assuming multiple design parameters are available).

If a user is updating an existing application using the application content, the system may automatically recognize the application type of the application that is being updated. In other cases, a user may be permitted to specify the application type of an application (e.g., by selecting from a list of application types) that is to be supplemented with the application content of a pre-existing application. Regardless of how the application type of an application which is being updated is determined, the application may be supplemented with the application content in a manner that is compatible with the application type.

In certain embodiments, a set of conversion templates may be utilized to transform or convert the application content into different types of applications. An appropriate conversion template may be selected for incorporating the content of the pre-existing application into an application which is being developed based on the application type selected for the application being developed. For example, separate conversion templates can be provided for converting or translating the content of a pre-existing application into an iPhone™ application, an Android™ application, an HTML 5 application, a NetTV™ application, a Facebook™ application, an application having a generic format, or other type of application. Each conversion template may include software code and/or rules which indicate how a particular application feature (e.g., input form, calendar or shopping cart) that was detected within the content of the pre-existing application is to be incorporated into a particular type of application. For example, the conversion templates may specify rules for copying an application feature or for incorporating an application feature utilizing a preassembled module into an application that is being developed. In certain embodiments, the conversion templates may also provide a means for converting the source code of a pre-existing application into another programming language that is compliant with a target device and which is compatible with development frameworks provided for a target device.

Before the detected application features of a pre-existing application are incorporated into the application being developed using the conversion templates, the user may select the application features and/or application modules that are to be included in the application. The selected application features (e.g., text, input forms, images, shopping carts or headings) may be utilized to populate the selected application modules. Once the application modules are populated with equivalent or similar features as those which were detected in the pre-existing application that was analyzed, a user may further customize and edit the application and the associated modules. For example, the user may be presented with tools that permit the user to add, edit or delete particular application features that have been added to the modules. Fonts, color schemes, and location of application features on the module interfaces can also be altered. Multimedia items, such as text, images, and videos, can also be added, deleted or edited.

In certain embodiments, one or more interfaces or pages (included within the content of the pre-existing application) are converted into separate modules for the application being constructed or updated. The user may further add preassembled application modules to the application in order to supplement the functionality and/or content of the application. For example, the user may add preassembled modules to the application that provide an event calendar, shopping cart, checkout page, photo gallery, upload form, message board or other application features, even if such features were not part of the content of the pre-existing application. These additional modules which are added to the application may also be customized by the user. For example, the user may add text, images or other types of multimedia data to populate the modules or select from a list of options for customizing the modules.

After a user has finished creating or updating an initial version of the application, the user may utilize a synching feature that facilitates the automatic updating of an application in response to detecting updates to a pre-existing application (e.g., updates to the interfaces or pages of the pre-existing application). For example, the user may be permitted to select an option that specifies whether the user would like an application to be synched with another application or set of applications. Assuming the user selects the option, the application features and/or application modules of the application which was updated or created would automatically be updated to reflect future changes or additions that are made to the pre-existing application. For example, if application features were added to an interface of the pre-existing application at some later time, the application which was created or updated using the content of the pre-existing application would automatically be updated to include the added application features. To determine whether the pre-existing application has been updated, the pre-existing application may be periodically analyzed, or may be analyzed in response to a command or request to check for updates.

It should be apparent that the application creation techniques described throughout this disclosure do not require a user to have any technical knowledge or programming knowledge. A user may simply identify a pre-existing application, and the application content associated with the pre-existing application may be utilized to create an analogous application having similar features or to update an application to include similar features. A set of tools may permit the user to further customize the application and to supplement the application with additional content. All of this may be performed in a user-friendly manner by providing some basic input (e.g., by selecting checkboxes or typing data into a text input field), and without requiring the user to write a single line of program code.

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Referring now to the drawings in which like numerals represent the same or similar elements and initially to FIG. 1, a system 100 is disclosed for creating or updating an application using application content in accordance with certain embodiments. As shown therein, a personal computing device 110, application hosting server 130, app building server 140 and target device 170 are connected to a network 190. Each of these devices may be configured to communicate via wired or wireless links, or a combination of the two. Each of these devices may also include one or more processors (e.g., central processing units) and one or more non-transitory computer storage devices (e.g., RAM, ROM, PROM, SRAM or other storage devices). The network 190 may be any type of network such as one that includes the Internet, a local area network (LAN), a wide area network (WAN), an intranet, etc.

A user 105 may operate the personal computing device 110 to communicate with the app building server 140 for the purpose of creating or updating an application 160. The app building server 140 includes an application builder 150 which provides a software development platform for constructing and updating applications 160. Amongst other things, the software development platform may permit the user 105 to design the application 160 by customizing multimedia content (e.g., text, images, video recordings or audio recordings), design aspects and functionality of an application 160.

An end-user 101 may download, install and execute an application 160 that has been created or updated using the application builder 150 on a target device 170. The target device 170 may represent any device that is capable of executing an application 160 that is created or updated using the application builder 150. The application builder 150 may permit a user 105 to create and update applications 160 that may be executed by any type of target device 170 including, but not limited to, mobile devices (e.g., an iPhone™ device, iPad™ device, iPod Touch™ device, Android™, device or Blackberry™ device), television-related devices (e.g., a NetTV™ device, Google TV™ device, Apple TV™ device, set-top boxes or particular televisions such as Samsung™ 8000 Smart TV), kiosks, desktop computers, or computing devices that provide access to applications in cars (e.g., via AutoNet™), planes (e.g., via SwiftBroadband™ service offered by Inmarsat™) or other types of vehicles.

To assist with building an application 160, the application builder 150 may include an application integrator 155. The application integrator 155 may analyze application content associated with a pre-existing application 135 and incorporate content and features of the pre-existing application 135 into the application 160 that is being developed (i.e., an application that is being created or updated). Generally speaking, the pre-existing application 135 may represent any application that is in existence at the time that the application builder 150 is being utilized to create or update an application 160. In certain cases, the pre-existing application 135 may be located on an app hosting server 130 and may be retrieved by the application builder 150 over a network 190 in response to a user 105 providing a network address (e.g., an IP address or URL) that indicates the location of the pre-existing application 135. A user 105 may also upload a pre-existing application 135 to the app building server 140 from a personal computing device 110.

The application integrator 155 may be configured to analyze or examine the application content associated with a pre-existing application 135 to detect one or more application features of the pre-existing application 135. The application features may relate to any content features, design features or functional features that are associated with an application. For example, detecting application features may involve detecting multimedia data, fonts, headings, input forms, photo galleries, shopping carts, event calendars, and credit card processing forms that are provided on interfaces of a pre-existing application 135. Detecting application features may further include detecting hyperlinks associated with social networking or social media sites such as Facebook™, Twitter™ or LinkedIn™. Detecting application features may also include detecting external data sources that may be utilized by a pre-existing application 135 (e.g.; data from other applications or data stored in a database over the Internet), detecting external software functions that are accessible to a pre-existing application 135 (e.g., functions provided by another application or operating system on a target device 170), and detecting hardware components (e.g., cameras, microphones or gyroscopes) on a target device 170 that are utilized by a pre-existing application 135.

As will be explained in further detail below, the application integrator 155 may create or update one or more application modules for the application 160 being developed using the application content from the pre-existing application 135. For example, the application integrator 155 may determine that application modules should be created for one or more interfaces or pages that are included in a pre-existing application 135 (e.g., interfaces associated with providing a contact page, shopping cart or photo gallery). Application features may then be incorporated into one or more application modules that are being created for the application 160. In the case that an application 160 is being updated, any application modules which were previously created may be updated with the detected application features. Additional details regarding the manner in which the content of a pre-existing application 135 may be utilized to create or update an application 160 are discussed in further detail below.

The personal computing device 110 may represent a desktop computer, laptop computer, smart phone, tablet device, smart television or other type of computing device. The personal computing device 110 may include a display and one or more input devices (e.g., keyboard, microphone, camera, video camera, analyzer, joystick, remote control device, etc). The personal computing device 110 may also include a web browser that is able to access the application builder 150 on the app building server 140. A user may manipulate interfaces served to the web browser by the app building server 140 in order to interact with the application builder 150 in constructing and/or updating applications 160.

The app building server 140 may generally represent any type of computing device. In certain embodiments, the app building server 140 comprises one or more mainframe computing devices that execute a web server configured to communicate with personal computing devices 110 over the Internet. A computer storage medium on the app building server 140 may store applications or software code that is configured to provide assistance to users in performing tasks related to creating or updating an application 160. Specifically, the app building server 140 may be configured to provide the application builder 150 to users 105 via an interface displayed on the personal computing devices 110. As mentioned above, the application builder 150 on the app building server 140 may include an application integrator 155 that is configured to incorporate application content and features from a pre-existing application 135 into an application 160 that is being created or updated on the app building server 140.

In certain embodiments, the pre-existing application 135 may be stored on a computer storage medium provided by an application hosting server 130. Like the app building server 140, the application hosting server 130 may represent one or more mainframe computing devices that execute a web server or may represent other types of computing devices.

It should be noted that the system in FIG. 1 is merely meant to demonstrate an embodiment of an operating environment that can be utilized in conjunction with the principles disclosed herein, and should not be construed as limiting in any manner whatsoever. The particular configuration in FIG. 1 can be altered in numerous ways without departing from the principles herein.

For example, the manner in which the application builder 150 is provided to the user 105 may vary. Rather than making the application builder 150 accessible to a user 105 over a network 190, the application builder 150 may represent an application or function that resides on the personal computing device 110 being operated by the user 105 (e.g., which is incorporated as part of a software development kit or other type of development framework). In such embodiments, the application builder 150 residing on the personal computing device 110 may directly utilize local copies of pre-existing applications 135 that are stored on the personal computing device 110 or pre-existing applications 135 that are available over the network 190 in order to create or update an application 160. Thus, any functionality of the app building server 140 which is described herein can alternatively be implemented by a personal computing device 110.

In addition, although it may be preferable to have one or more target devices 120 connected to the network 190 in order to transfer an application 160, or updates to an application 160, directly to the target device 170, it is not necessary for the target device 170 to be connected to the network 190. The application 160 or associated updates may be transferred to the target device 170 in other ways (e.g., by downloading or storing the application on an external storage medium and utilizing the storage medium to transfer the application or associated updates to the target device 170).

It should also be understood that while the disclosure herein may primarily discuss utilizing a pre-existing application 135 to create, generate, or build another application 160, it should be understood that the principles discussed herein may also utilize a pre-existing application 135 to update or supplement an existing application. Thus, any reference to creating, generating or building an application should also be understood to apply to updating or supplementing an application.

Based on the above, it should be apparent that the system 100 illustrated in FIG. 1 may be varied in numerous other ways in addition to those modifications explicitly mentioned in this disclosure.

Moving on to FIG. 2, a detailed view of a system 200 for providing an application builder 150 is disclosed in accordance with certain embodiments of the present invention. As shown therein, a plurality of software components (such as an application integrator 155, tools 270, application analyzer 220, etc.) comprising computer readable software instructions are stored on a computer storage device 201 (e.g., RAM, ROM, PROM, SRAM, etc). The storage device 201 is in communication with one or more processors 202 that may be configured to execute the instructions associated with software components.

It should be noted that although the components on the storage device 201 may be described throughout this disclosure as software modules, such is not necessary. As explained above, embodiments described herein may be hardware-based, software-based or a mixture of both hardware and software elements. Furthermore, while the components may be illustrated as separate and distinct components, it should be recognized the components can be combined in any manner (e.g., all of the components may be executed as a part of a single program or as separately executing processes or threads) and that the functions performed by these components may overlap in some instances. To demonstrate the functionality performed by these components, reference will be made to FIGS. 3A-3C, which disclose exemplary interfaces associated with providing an application builder 150.

Amongst other things, the application builder 150 includes an application integrator 155 and a set of tools 270. The application integrator 155 may be configured to analyze content of a pre-existing application 135 and to utilize the content to create or update an application 160 that may be executed by a target device 170. A user 105 may initially select or identify the pre-existing application 135 that is to be used. For example, the user may enter or provide uniform resource locators (URLs) or network addresses (e.g., IP addresses) that identify the locations of one or more pre-existing applications 135 that may be utilized to create or update an application 160. A user 105 may also upload one or more pre-existing applications 135 to create or update an application 160. A user may identify pre-existing applications 135 in other ways as well.

It should be recognized that multiple pre-existing applications 135 may be utilized to create or update an application 160. That is, the user 105 may specify that content from a variety of different pre-existing applications 135 is to be utilized to create or update a single application 160. For example, a user may upload a first pre-existing application 135 to the app building server 140 and specify a URL that indicates the location of a second pre-existing application 135 that is located on an app hosting server 130. Both pre-existing applications 135 may be utilized to create or update an application 160.

After a user has identified a pre-existing application 135 that will be used in creating or updating an application 160, an application analyzer 220 may analyze the content of the pre-existing application 135 to determine application modules that are to be created (or updated) for an application 160. For example, the application analyzer 220 may identify one or more application interfaces that are to be converted into application modules for the application 160 or one or more application interfaces that may be used to update modules that have already been created for the application 160.

Generally speaking, each application module may be associated with two distinct sets of interfaces: a user interface (or set of interfaces) that is displayed to an end-user 101 when the application 160 is eventually executed on a target device 170 (e.g., such as the interface display on the mobile device illustrated in FIG. 4); and a customization interface (or set of interfaces) that is provided via the application builder 150 to assist users 105 that are developing the application 160 to customize features of the application. In certain embodiments, the features detected on an interface of a pre-existing application 135 may be incorporated into an application module for the application 160 being created or updated. The customization interface associated with the application module then permits a user 105 to customize the features (e.g., content, design and functionality) of the application module. For example, the detected features may be edited or deleted, and the user 105 may add additional features to the application module. After the user is done customizing the modules of an application 160, the application may be downloaded to a target device 170 by an end-user 101. When the application 160 is executed by the target device 170, the user interfaces displayed to the end-user 101 via the application 160 will include all of the features and customization preferences specified by the user 105 for the application modules.

In certain embodiments, to determine the application modules that are to be created or updated using the content of the pre-existing application 135, the application analyzer 220 may initially traverse or crawl the hyperlinks, links or buttons (e.g., on a menu) in the pre-existing application 135 to identify the various interfaces or pages which are provided by the pre-existing application 135. In other embodiments, the application analyzer 220 may examine manifest files, metadata files, source code files or other files included in a packaged application file to identify the application modules that are to be created or updated for an application 160. Regardless of how the interfaces are identified, a corresponding application module may be created or updated for each identified interface.

In addition to identifying the application modules that are to be utilized in creating or updating the application 160, the application analyzer 220 may analyze or examine the application content of a pre-existing application 135 in order to detect application features of the pre-existing application 135. This may include analyzing the source code of an application, files and directories included in an application package, or any other type of data associated with a pre-existing application 135.

The application analyzer 220 may utilize a rule set 210 in analyzing the content of the pre-existing application 135. The rule set 210 may be utilized to detect any type of application feature, Separate rule sets 210 may be provided for each type of application (e.g., separate rule sets 210 may be provided for iPhone™, Android™, NetTV™ and HTML 5 applications). Each rule set 210 may represent a set of rules or policies which are utilized to identify application features for a particular type of application.

In analyzing the content of the pre-existing application 135, the application analyzer 220 may utilize a variety of different analysis tools (e.g., regular expressions, string querying functions and crawlers) to detect application features. For example, in order to detect images utilized by a pre-existing application 135, the rule set 210 may include rules which utilize regular expressions or string querying operations to search the application content for particular image file extensions (e.g., .jpg, .gif, or .png). In other cases, images may be detected by analyzing the contents of a resource directory included in an application package that includes all of the images and multimedia content that is utilized by the pre-existing application 135. Similarly, in certain embodiments, in order to detect the presence of an input form on an interface provided by an application, the rule set 210 may include one or more rules that may be utilized to search the application content for form elements or input elements. The manner in which images, input forms or other types of application features are detected may vary depending upon the application type of the pre-existing application 135. As will be discussed in further detail below, some or all of the application features detected in the content of the pre-existing application 135 may be incorporated into the application 160 that is being created or updated.

The type of application features that may be detected by the application analyzer 220 can vary greatly. For example, the application analyzer 220 may utilize a rule set 210 to identify application features such as multimedia content that is displayed by an application, functional application features (e.g., forms, RSS/Atom feeds, scrollers, photo galleries, message boards, messaging features or shopping carts) that are provided by the application, font characteristics for text utilized by the application (e.g., size, style and color), titles or headings used on the interfaces of the application, and navigation menus utilized by a pre-existing application 135. Other application features that may be detected by the application analyzer 220 may include features related to gestures (e.g., tap, double tap, swipe, flick, pinch, or rotate gestures) on a touch screen device. For example, a rule set 210 may include rules for detecting gestures that are used or recognized by a pre-existing application 135, the interface elements or content that is associated with gestures, and any actions which occur in response to the application 135 detecting or receiving gestures.

Detecting application features may also involve detecting external data that is available to a pre-existing application 135 (e.g., data which is external to the application). For example, an application on a smart phone may utilize data from other applications that are installed on the same target device 170, such as data from a call log, data related to stored SMS text messages, data in a calendar application or data that indicates networking settings for an operating system (e.g., which indicates whether the Wi-Fi antenna is turned on/off). Applications may also be permitted to utilize data which is accessible over a network 190 (e.g., databases accessible on a website via the Internet or databases accessible via a cable TV network). Thus, a rule set 210 may include rules for detecting any type of external data that is available to a pre-existing application 135.

Detecting application features may further include detecting external software functions that are available to a pre-existing application 135. Specifically, an application may utilize software functions provided by other applications on a target device 170 or software functions provided by an operating system of a target device 170. For example, a pre-existing application 135 for a smart phone may be permitted to utilize software functions for sending, receiving or processing SMS text messages, or checking the remaining battery life of a smart phone. Thus, a rule set 210 may include rules for detecting any type of external software function that is available to a pre-existing application 135.

The rule set 210 may further be utilized to detect hardware components of a target device 170 that are accessible to a pre-existing application 135. The particular hardware components accessible to a pre-existing application 135 may vary depending upon the type of target device 170 a pre-existing application is adapted for or installed on. For example, in the case a mobile application, the rule set 210 may be configured to detect whether a pre-existing application 135 utilizes, or has access to, a camera, microphone, speaker or gyroscope provided on the mobile device. Similarly, in the case of a television application, the rule set 210 may be configured to detect whether a pre-existing application utilizes, or has access to, a Wi-Fi antenna, television speakers, or external surround sound speakers. Accordingly, a rule set 210 associated with a pre-existing application 135 may include rules for detecting any type of hardware component that is available to the pre-existing application 135.

In many cases, an application may be embodied as an application package that includes a collection of files and directories. For example, an Android™ application package file (APK file) having an “.apk” extension is utilized for applications that are developed for the Google™ Android™ operating system. Similarly, an application package file having an “.ipa” extension (IPA file) is utilized for applications that are developed for an Apple™ iOS device (e.g., iPhone™, iPod Touch™, or iPad™). The APK and IPA files include a package of files and directories which collectively comprise a single application. Many other application types or formats also utilize a packaged set of files to implement an application. As will be demonstrated by the discussion provided below, any of the files, directories or other data included in an application package (for any application type) may be analyzed by the application analyzer 220 to detect application features of a pre-existing application 135. A separate rule 210 may be utilized for detecting application features for each type of application package.

To demonstrate how an application package may be analyzed to detect features of a pre-existing application 135, consider an APK file that is provided for an Android™ application. The APK file will likely include, inter alia, the following directories and files:
1) MANIFEST.MF: a file that includes a listing of files that are included in an APK package;
2) CERT.RSA: a file that includes a certificate of a public key to verify a signature;
3) CERT.RS: a file that includes a list of resources and SHA-1 digest;
4) AndroidManifest.xml: a file that describes the application and the components of the application. Amongst other things, the file lists the activities, services, broadcast receivers, and content providers that the application utilizes. (Note the terms “activities”, “services”, “broadcast receivers” and “content providers” are specific terms utilized in the Android™ development framework and are discussed in further detail below). This file also names the classes that implement each of the components and publishes the capabilities of each component. The file includes data that indicates code that should be invoked on key system events, such as starting up activities and other types of activities. The file further includes permission information that indicates the permissions the application will need in order to function properly (e.g., an application may need permissions for reading contact information stored in a contact list application, permission to change the wallpaper on a mobile device, permission to access the Internet, permission to utilize a camera on a target device 170, etc.);
5) classes.dex: an executable file for the compiled application;
6) bin: a directory including compiled data for the application;
7) src: a directory that includes the source code files (e.g., which are implemented in Java) for the application;
8) res: a directory that includes all of the resources used in an application including images, audio recordings, videos, text strings, layout information (e.g., XML) for user interfaces, and themes; and
9) lib: a directory that includes third-party Java™ JAR files utilized by the application.

In addition to any other files that are included in an APK file, any of the files or directories listed above may be analyzed by the application analyzer 220 to detect application features of a pre-existing application 135 that was developed for the Android™ operating system. As explained above, a rule set 210 for detecting application features in an Android™ application may be utilized to identify features of a pre-existing Android™ application 135. The AndroidManifest.xml file may be particularly useful to analyze in many cases. In this file, the <application> element (and in particular, the “Android:icon” attribute associated with this element) may be searched for (e.g., using a regular expression) and analyzed to identify an icon that is to be associated with the application on a menu of a mobile device (i.e., the icon that is displayed on a menu of an Android™ device which may be selected by an end-user 101 to execute the application).

As mentioned above, the file AndroidManifest.xml file lists the activities, services, broadcast receivers and content providers that comprise an application. Analyzing these application components may useful to detect various types of application features. An “activity” represents a single screen or interface. Thus, by analyzing the data in the file which includes information on activities, the different interfaces provided by an Android™ application may be identified along with other relevant information that is associated with the interfaces.

The “services” data stored in a file can indicate processes of the application which run in the background of an application or which perform work for remote processes. For example, a service might play music in the background while the user accesses a separate application, or a service may be configured to fetch data over a network without blocking user interaction with an activity. Thus, by analyzing the “services” data in the AndroidManifest.xml, the application analyzer 220 may identify the background processes that may be performed by the application.

A “content provider” represents a component of an Android™ application that manages the data for the application (e.g. manages data stored in an SQLite database, on the web, or any other persistent storage location the application can access). The content provider also controls access to the data by other applications that seek to query or modify the application. Thus, by analyzing the content provider data, the application analyzer 220 may utilize and retrieve the underlying data of an Android™ application and can identify the applications that have permission to utilize the data.

Finally, a “broadcast receiver” is a component that responds to system-wide broadcast announcements on target devices 170 that include an Android™ application. For example, a broadcast receiver may announce that the screen of a target device 170 has been turned off, the battery is low, or a picture was captured. The Android™ applications themselves can also initiate broadcasts (e.g., to let other applications know that some data has been downloaded to the device and is available for use). Thus, by analyzing data in the AndroidManifest.xml that relates to the broadcast receivers on the application, the application analyzer 220 can determine how the application responds to announcements by other applications or events on the target device 170.

In addition to the above, the AndroidManifest.xml file may also be utilized to determine a set of permissions assigned to a pre-existing application 135. The permissions may indicate, inter alia, content (e.g., data from other applications) that is available to the pre-existing application 135, software functions (e.g., functions for sending and receiving text message or collecting statistics on battery life) that are available to the pre-existing application 135, and hardware components (e.g., a camera or an antenna) that are available to the pre-existing application 135. To determine the permissions that are assigned to the pre-existing application 135 or requested by a pre-existing application 135, the application analyzer 220 may examine the <uses-permission> elements in the file and may search for the particular constants within the “name” attribute of <uses-permission> element. Exemplary constants which may be searched for by the application analyzer 220 may include:
ACCESS_WIFI_STATE: allows an application to access information about Wi-Fi networks;
ADD_VOICEMAIL: allows an application to add voicemails into the system;
BATTERY STATS: allows an application to collect battery statistics;
BLUETOOTH: allows an application to connect to paired Bluetooth™ devices;
CALL_PHONE: allows an application to initiate a phone call;
CAMERA: allows an application to access the camera device on the mobile device;
READ_CALENDAR: allows an application to read the user's calendar data;
READ_CALL_LOG: allows an application to read the user's call log;
READ_CONTACTS: allows an application to read the user's contacts data;
READ_HISTORY_BOOKMARKS: allows an application to read the browsing history and bookmark information;
RECEIVE_SMS: allows an application to monitor incoming SMS messages, to record incoming SMS messages and perform processing on the incoming SMS messages;
SEND_SMS: allows an application to send SMS messages; and
SET_TIME_ZONE: allows applications to set the system time zone.

The application analyzer 220 may search for many additional constants (besides those listed above) within the content of the AndroidManifest.xml file in order to determine permissions that have been assigned to or requested by a pre-existing Android™ application 135. After identifying permissions that are available to a pre-existing application 135, the application integrator 155 may incorporate equivalent or similar permissions into the application 160 which is being created or updated using the application builder 150.

In addition to the specific examples described above, the AndroidManifest.xml file may be analyzed to detect numerous other types of application features associated with a pre-existing application 135. The other files and directories included in an APK file may also be useful for detecting application features. For example, the application analyzer 220 may examine the contents of the “res” directory to identify or retrieve multimedia data (e.g., images, audio recordings, video recordings and text strings) that is included in an application. This directory may also be utilized to detect layout or design information for user interfaces displayed by a pre-existing application 135. Likewise, the MANIFEST.MF file, which identifies all of the files included in an Android™ application, may be analyzed to determine whether a particular file is present within an APK application package. As mentioned above, the “src” directory in an APK file includes the source code files (e.g., Java™ files) for an Android™ application and the “lib” directory includes third-party Java™ JAR files (i.e., Java™ Archive files) utilized by the application. In certain cases, the application analyzer 220 may also be configured to examine the source code included in the files of these directories in order to detect the features of a pre-existing application 135.

Based the above discussion, it should be apparent that an APK package for a pre-existing Android™ application 135 may be analyzed in various ways to detect a wide variety of different features. In addition to the specific examples provided above, the application analyzer 220 may analyze the contents of an APK file in numerous other ways in order to detect the features of a pre-existing Android™ application 135. In addition, it should also be apparent that the same principles described above for detecting application features for an Android™ application may also be applied to detecting features of other types of applications. Hence, an appropriate rule set 210 may be defined for analyzing the content of any type of application file and for detecting application features associated with any type of pre-existing application 135.

For example, as explained above, an IPA file represents an application package that is compatible with an iOS™ device. Since the content, structure and hierarchy of an IPA file is different from the Android™ APK file structure described above, a different rule set 210 may be provided for analyzing and detecting application features in a pre-existing iOS™ application 135. For example, rather than analyzing the content of the AndroidManifest.xml file (e.g., the “Android:icon” attribute associated with the <application> element) for identifying an icon associated with a pre-existing Android™ application 135, a rule set 210 provided for analyzing a pre-existing iOS™ application may include rules for analyzing the “iTunesArtwork” file in an IPA application package to identify the application icon. This rule set 210 may also have rules for extracting metadata stored in the iTunesMetadata.plist file of an IPA file and rules for analyzing the contents of the Payload directory, which includes the actual application data for an iOS™ application. As mentioned above, any file or directory included within an IPA file or other type of application package may be analyzed to detect features of a pre-existing application 135.

It should be understood that rule sets 210 described herein are not limited to detecting features in files associated with an application package or archive file. In many cases, a rule set 210 may be configured to analyze a standalone application file which is not comprised of a package of files or directories. Generally speaking, the rule sets 210 may be utilized to analyze any data that is useful for detecting features of a pre-existing application 135. Moreover, while certain application formats may be more amenable to feature detection techniques than other types of application formats, a rule set 210 can be designed to detect features for any type of pre-existing application 135.

Moving on, after or while the analyzing operations are being performed, the application integrator 155 may incorporate some or all of the detected application features of a pre-existing application 135 into an application 160 that is being created or updated. In certain embodiments, a set of conversion templates 230 may be utilized to convert the content of a pre-existing application 135 into different types of applications 160. For example, separate conversion templates 230 can be provided for converting or translating the application content of a pre-existing application 135 into an HTML 5 application, an iPhone™ application, an Android™ application, a NetTV™ application, a Facebook™ application, an application for a particular type of kiosk, an application for use in a vehicle device (e.g., car device or plane device), and other types of applications.

In certain embodiments, a conversion template 230 may be utilized to create or update a generic application 160 which has a standardized format and which stores the features included in the application 160 in a uniform manner to facilitate conversion of the generic application into other types of native applications (e.g., applications for mobile devices such as an iPhone™ device, Android™ device, Blackberry™ device or other type of device). In certain cases, the generic application may include a configuration file that includes a list of the application features for the generic application. By storing the features in a uniform manner that can be easily processed and analyzed to identify the features of the application 160, additional applications can be readily created or updated using the generic application.

The conversion templates 230 may include functions and rules for incorporating detected application features into an application that is being created or updated. The application integrator 155 may directly copy particular types of application features (e.g., text and images) into the application 160 or may incorporate equivalent or similar application features into the application 160 using preassembled modules. The conversion template 230 may include functions and rules for converting or translating the source code, or a portion of the source code, associated with a pre-existing application 135 into a different language associated with a particular application type. For example, in the case that the application content of a pre-existing application 135 is being converted into a web application, a conversion template 230 may be utilized for converting the source code into an HTML 5 application that may be executed in a web browser. As another example, in the case that the application content is being converted into an iPhone™ application, a conversion template 230 may be selected for converting the source code of a pre-existing application 135, or portion thereof, to an application that is written in programming language such as Objective C.

The conversion template 230 may also include rules for utilizing features or functions provided by a development framework (e.g., a software development kit). In certain embodiments, a conversion template 230 may utilize classes or files that provide particular types of functionality or may utilize the development framework to compile an application. For example, the conversion template 230 for converting the source code of a pre-existing application 135 into an iPhone™ application may also provide instructions for utilizing a development framework, such as the Cocoa Touch API, which is provided to assist developers in constructing applications for the iPhone™.

A conversion template 230 for a particular type of application may indicate how an application feature (e.g., text, images, input form, calendar, RSS feed or shopping cart) of a pre-existing application 135 is to be incorporated into the particular application type associated with the template 230. For example, the conversion templates 230 may specify rules for directly copying an application feature into an application or for utilizing a preassembled module to incorporate a feature into an application.

The manner in which the application features are incorporated into the application 160 being created or updated may vary depending upon the complexity of the application feature. Less complex application features, such as any multimedia data, may be incorporated into the application by copying the data directly into modules for the application 160 or by including a reference to the multimedia data in the application modules. For example, an image can be directly copied and utilized by an application 160 by copying the file that includes the image and packaging the file with the application 160. Rather than packaging the image file with the application 160, the application 160 may simply include a reference (e.g., a URL or IP address) that indicates the location of the image file and the application 160 may retrieve the image file when needed.

Likewise, the conversion templates 250 may be able to extract other types of application features (e.g., text strings, titles, headings and fonts) in a relatively simplistic manner by utilizing regular expressions. The extracted information associated with the application feature can then be utilized to define or populate appropriate parameters for an application module. For example, if an application module is created for an application interface in the pre-existing application 135 that was titled “Homepage”, the title may be extracted from the application content and utilized to populate a parameter for naming the application module in the application 160 that is being created or updated.

In some embodiments, preassembled modules may be utilized for incorporating application features into an application 160. These modules may be particularly useful when incorporating complex or functional application features into an application 160 that is being created or updated. Accordingly, it may be recognized that certain features will commonly be detected in a variety of different applications 135, such as input forms (e.g., which are often found on an interface for providing a contact page or on an interface for providing a survey page), photo galleries, shopping carts, event calendars (e.g., which provide a listing of events along with times and dates for the events), message boards, RSS feeds, or product listings (e.g., which list products and/or services that are being sold along with related data such as pricing information and product descriptions). Since these features are common to many applications, preassembled modules may be provided for each of these features for a variety of different application types.

For example, in the case of an input form, separate preassembled modules may be provided for adding an input form to an HTML 5 application, iPhone™ application, Android™ application, NetTV™ application, Autonet™ application, or other type of application. If the user 105 was creating an HTML 5 application using the content of a pre-existing application 135, a preassembled module for providing an input form in an HTML 5 application may be automatically selected and added to the user's application 160 in response to the application analyzer 220 detecting an input form in the content of the pre-existing application 135. The application content associated with the input form may then be utilized to customize the preassembled module that was added. For example, the name of the particular input fields (e.g., name, email address and comments), the type of particular input fields (e.g., checkboxes, text fields, radio buttons, hidden input elements or submit buttons) and the appearance of the input fields (e.g., color or size of input fields) can be customized to mimic the attributes of the input form that was included in the content of the pre-existing application 135. In doing so, the preassembled module associated with the input form may be customized or tailored to provide an input form for the application 160 being created or updated which is the same or similar to the input form provided by the pre-existing application 135.

As another example, suppose that an event calendar was detected in the content of a pre-existing Android™ application 135 that was being utilized to create an iPhone™ application. In this case, a preassembled event calendar module specifically designed for providing an event calendar on an interface of an iPhone™ application may be added to the iPhone™ application that is being created. The event calendar module may be preconfigured to provide all of the typical functionality associated with providing an event calendar. Thereafter, the content of the pre-existing application 135 may be utilized to customize the event calendar module that was added to the iPhone™ application 160 being created. For example, the dates, times, other event information specified by the event calendar on the pre-existing application 135 may be extracted and utilized to populate the preassembled module for the event calendar. Similarly, any color themes utilized by the event calendar on the pre-existing application 135 may be utilized to customize the appearance of the event calendar provided by the preassembled module.

Preassembled modules may be provided for nearly any type of application feature. For example, preassembled modules can be provided for shopping carts, photo galleries, video galleries, product listings or any other type of application feature that may be included in an application 160. Any preassembled module can be customized or tailored with the information from the application content of a pre-existing application 135 in a similar manner to the examples described above.

After the features of a pre-existing application 135 have been incorporated into the application 160 being created or updated, the tools 270 may permit a user 105 to customize (e.g., add, delete or modify) the application modules and/or application features that have been incorporated into the application 160. This may include modifying the content, appearance or functionality provided by the application modules. The tools 270 may further permit the user 105 to add new modules that are not derived from the content of the pre-existing application 135.

A synching feature may be provided as part of the tools 270 or other component of the application builder 150. The synching feature permits a user 105 to “sync” an application 160 being developed with one or more pre-existing applications 135. The user 105 developing the application 160 may be permitted to select an option that specifies whether the user 105 would like the application 160 to be synched with one or more pre-existing applications 135. By synching an application 160 with a pre-existing application 135, the application 160 can automatically be updated to include (or exclude) features of the pre-existing application 135 in response to detecting updates to the pre-existing application 135. This may include updating application modules of the application 160 to reflect future changes or additions that are made to the pre-existing application 135.

To illustrate the synching feature, consider an exemplary situation in which a user 105 selects an option for synching an application 160 with a pre-existing application 135 that was utilized to create or update the application 160. In some cases, the pre-existing application 135 may be available via a digital distribution platform (e.g., the Apple AppStore™) that permits end-users to download and install applications. Periodically, the pre-existing application 135 may be updated to include new application features or to exclude previously included application features. For example, a new version of the pre-existing application 135 may be made available that includes new multimedia content, functional elements (e.g., input forms or photo galleries), or interfaces. The application integrator 155 may periodically analyze the content of the pre-existing application 135 to determine whether updates have been made. In certain embodiments, this may be done automatically after certain time periods have lapsed, as a result of a request to check for updates which was issued by the user 105 or in other ways. If it is determined that the pre-existing application 135 has been updated, the application 160 which was created or updated using the content of the pre-existing application 135 may automatically be updated to include the added application features or to exclude application features that had been removed from the pre-existing application 135.

Once the user 105 is done customizing the application 160 and a version of the application 160 is finalized, the application builder 150 may assist the user 105 with distributing the application 160. For example, the application builder may include an application distributor component (not shown) that is configured to transmit the application 160 to a target device 170 over a network 190. The application builder 150 may also be configured to submit the application 160 to one or more digital distribution platforms that permit end-users 101 to download and/or purchase applications. Exemplary digital distribution platforms may include the Android Market™, the Apple App Store™, or any other service that permits users to download and/or purchase applications 160. In certain embodiments, if an application 160 is synched with a pre-existing application 135, the application distributor component may transmit updates to a digital distribution platforms and/or target devices 170 in response to detecting that the pre-existing application 135 has been updated.

FIGS. 3A-3C illustrate exemplary interfaces that may be displayed by the application builder 150 to a user 105 in order to permit the user 105 to create or update an application 160. FIG. 3A discloses an exemplary interface 300A that may initially be displayed to a user 105 when the user 105 accesses the application builder 150 (e.g., by accessing a website provided on an app building server 140 which provides the application builder 150 to the user 105). As shown therein, a user 105 may select a first option 301 for creating a new application 160 from scratch, a second option 203 for importing content from a pre-existing application 135, and a third option 303 for updating an existing application 160.

If the user 105 selects the first option 301, the user may be presented with a set of tools 270 for creating an application 160. The tools 270 may permit the user 105 to construct an application 160 in various ways. The tools 270 may permit the user 105 to design interfaces for the application and add various types of preassembled modules to the application 160. The tools 270 may also include application templates that may be customized by the user 105 for designing the application. For example, a user 105 may select an application template for creating an application 160 for a particular type of business (e.g., restaurant, law firm, accounting or construction company) or for a particular topic or hobby (e.g., a photo album). Each application template may include a plurality of preassembled modules or interfaces.

For example, an application template for a law firm may include preassembled modules that provide an About Us module (e.g., which can be customized by the user 105 to provide a description of the firm), Contact module (e.g., which can be customized by the user 105 to provide contact information), an Employee module (e.g., which can be customized to describe the attorneys who work at the firm), a Consultation Form module (e.g., which permits potential clients to fill out an input form designed by the user 105 and to send comments to an email address specified by the user 105), and other types of modules. In customizing these modules, a user 105 may select different options (e.g., using check boxes or radio buttons), enter information into text input fields (e.g., name and contact information) and/or upload content (e.g., images, videos, or images) to populate the preassembled modules associated with the application template.

If the user 105 selects the second option 302 (i.e., “Import content from existing application”), the user 105 may be presented with an interface that permits the user 105 to identify a pre-existing application 135 that is to be utilized in creating an application 160. A user 105 may identify pre-existing applications 135 located on one or more separate websites. In other cases, a user 105 may upload or otherwise provide the application builder 150 with access to a copy of the pre-existing application 135.

In certain embodiments, a separate module or interface may be established for one or more of the interfaces associated with the pre-existing application 135 and the modules may be populated with features which are the same or similar to those included on the interfaces. In some cases, preassembled modules may be utilized to facilitate the incorporation of particular application features.

If the third option 303 (i.e., “Update Existing Application”) is selected, the user 105 may be presented with a list of one or more applications 160 that the user 105 had previously created or had begun creating. The user 105 may then select an application 160 from the list, and utilize the tools 270 to update or modify the selected application 160. The user 105 may also be permitted to select or identify one or more pre-existing applications 135 that should be utilized to supplement the existing application 160. If user 105 opts to supplement the application 160 with application content, the user 105 may identify the application content in the same manner described above.

FIG. 3B illustrates an exemplary interface 300B that may be displayed by the application builder 150 to a user 105 after the application integrator 155 has created application modules using the content of a pre-existing application 135 that was identified by the user 105. In this example, the application analyzer 220 scanned the contents of a pre-existing application 135 for a construction company which included four interfaces: an About Us page, a Contact page, a Photo Gallery page (e.g., showing photos of completed construction projects), and a Services page (e.g., which describes the services performed by the construction company). As a result, the application integrator 155 created four modules (i.e., an About Us module, a Contact Page module, a Photo Gallery module and a Services module) for the application 160. In certain cases, the conversion templates 230 may specify that each of the modules created by the application builder 150 are to be named based on the title of an interface or headings found on the interface.

The interface 300B includes two primary windows: a page detail window 320 and a simulation window 330. The simulation window 330 illustrates how the application 160 being created will appear and function when the application 160 is downloaded and/or installed on a target device 170 or executed on a target device 170. For example, the simulation window 330 may display the interfaces that will be displayed when the application 160 is executed on a target device 170. The particular interface displayed in the simulation window 330 in FIG. 3B may represent the home menu for an application that permits an individual to select or access different modules for the application. The user 105 may select (e.g., with a mouse or by tapping a touch screen) the icons in the simulation window 330 in order to access or view the interface that would be displayed on a target device 170 if that particular icon had been selected by and end-user 101. For example, clicking on the camera icon would cause the simulation window 330 to display the photo gallery page in the same or similar manner as it would be displayed on a target device 170.

The page detail window 320 provides a list of buttons (i.e., About Us button 320A, Contact page button 320B, Photo Gallery button 320C, and Services button 320D), each of which is associated with a particular application module that has been created for the application 160. The buttons 320A-320D correspond to the icons in the simulation window 330. Each one of the buttons includes a remove option 321 that permits a user to delete the entire application module. Assuming the user 105 does not wish to delete an application module, the user 105 may click on or otherwise select a button in the page detail window 320 in order to edit the contents of the associated module. Specifically, in response to clicking on a button for a module, a customization interface may be presented to the user 105 that permits the user to customize the features of the module. For example, if the user clicked on the About Us button 320A, the user 105 may be presented with a customization interface that includes a form (e.g., which includes text boxes, radio buttons and check boxes) for permitting the user to edit the text and images displayed on the About Us page of the application 160. Likewise, if the user 105 clicked on the Photo Gallery button 320C, the user 105 may be presented with a customization interface that includes a form for permitting the user to upload new photos to the gallery, to delete existing photos in the gallery, or to make other types of modifications to the Photo Gallery module (e.g., such as changing the heading or text). Selecting a button 320A-320D may also permit the user 105 to modify the titles 335, fonts, color schemes, interface layouts, headings, alignment settings and other features of the application modules.

When a user accesses (e.g., by selecting a button 320A-320D) a customization interface associated with one of the modules in the page detail window 320, a user 105 may view the application features from the pre-existing application 135 that have been incorporated into the modules. As explained above, the user may then edit the features of the application modules. For example, in generating the About Us module, the application integrator 155 may extract text, hyperlinks, images, and other content from the About Us page on a pre-existing application 135 and incorporate this content into the About Us module for the application 160 being created. As explained above, the content from the pre-existing application 135 may also be utilized to populate portions of preassembled modules used for constructing certain types of modules. For example, the application builder 150 may include a preassembled module for providing a photo gallery. Thus, if the application analyzer 220 detects that a photo gallery is provided as part of the pre-existing application 135, a preassembled photo gallery module can be utilized to create a photo gallery for the application 160. Initially, the preassembled module may already include functionality for displaying a photo gallery, but may not include any images to be displayed in the photo gallery. Thus, the images from the photo gallery provided by the pre-existing application 135 can be extracted and utilized to populate the preassembled module for the photo gallery.

FIG. 3C illustrates an exemplary interface 300C that may be displayed in response to a user 105 selecting the contact icon in the simulation window 330. In response to a user selecting the contact icon in the simulation window 330, the simulation window 330 may display the contact module that has been populated by the application integrator 155 with content from the Contact page for the pre-existing application 135 associated with the construction company. FIG. 4 illustrates a corresponding interface for the pre-existing application 135 which served as a basis for creating and populating the Contact module for the application 160 which is displayed in the simulation window 330 of FIG. 3C.

In FIG. 4, a mobile device 401 renders an interface 420 that provides a Contact page for the construction company. The text displayed on the interface 420 provides contact information (e.g., street address, email address and phone number) for the construction company. The interface 420 also includes a title bar 410 that displays the name of the company or other information, a heading 431, a navigation menu 450, and an input form 430 that permits individuals to send comments to the company (e.g., the input submitted via the form may be emailed to the construction company). The input form 430 includes a first input field 435A for providing a name, a second input field 435B for providing an email address, and a third input field 435C for specifying comments. After the user 105 has filled out the form 430, the user may press the “Submit” button to send the contents of the form to the company.

The Contact module (in FIG. 3C) derived from the interface of the pre-existing application 135 (FIG. 4) may represent a preassembled module for creating a contact interface that has been populated with application features that were detected by the application analyzer 220. Before being populated with the application features, the preassembled contact module may reserve variables for specifying certain features, namely the module title, address information that is displayed by the module, and links on a menu that is displayed by the module. The preassembled contact module may also include a function for creating a contact form.

One or more conversion templates 230 may be utilized to populate the variables of the preassembled contact module. For example, the variable associated with displaying contact information may be populated with contact information (e.g., the address, phone number and email) that was displayed on the interface 420 of the pre-existing application 135. To accomplish this, the application analyzer 220 may utilize the rule set 210 to detect the text that is displayed on the interface 420 and may further utilize a conversion template 230 to copy the text to the appropriate variable associated with the preassembled contact module. The title 331 or name of the module was determined by the heading 431 which was provided on the interface 420 (in other cases the title bar 410 may serve as the basis for naming the module). To accomplish this, the application analyzer 220 may utilize the rule set 210 to detect the heading (e.g., by detecting text that is above a certain size font and/or utilizing regular expressions) and may further utilize a conversion template 230 to copy the heading to the appropriate variable associated with specifying a title for the preassembled contact module.

Similarly, a menu 333 displayed at the bottom of the module includes similar links to the menu 450 that was included in the pre-existing application 135 (although the links are not shown in detail in FIG. 3C). To accomplish this, the application analyzer 220 may utilize the rule set 210 to detect the menu 450 (e.g., by detecting hyperlinks or buttons associated with the menu items) and may further utilize a conversion template 230 to populate variables associated with the preassembled contact module. The variables may define the name of the menu items (e.g., About Us, Photo Gallery, Contact Page and Services) which are displayed on the menu 330 and the links to interfaces associated with the with menu items. In some cases, the conversion template 230 may associate the menu items with internal links to other application modules that have been created for the application 160.

The Contact module also includes the contact form 430 that was displayed on the interface 420 of the pre-existing application 135. In order to incorporate the contact form 430 into the Contact module, the application analyzer 220 may search the content of the pre-existing application 135 (e.g., utilizing regular expressions and/or string querying operations), including the source code files, for code that provides input fields in accordance with the rule set 210. The application analyzer 220 may extract relevant information associated with the form (e.g., the types of input fields, the names of the fields, the color and size of the input fields and an e-mail address for forwarding input submitted via the contact form). The conversion template 230 may provide this information to a function that generates an equivalent or similar form.

After the application modules are created for the application 160, the tools 270 provided by the application builder 150 may permit a user 105 to modify the modules that have been created by the application integrator 155. The tools 270 may also permit the user to delete modules from or to add additional modules to the application 160. For example, if the user 105 desired to add a module to the application 160 that was not derived from the application content, the user 150 may click on a button 310 to create a new page or module. In order to allow the user 105 to quickly create a module, the user 105 may be permitted to select from a plurality of preassembled modules. For example, the user 105 may select a preassembled module for creating an image gallery, a links page, a contact page, an RSS feed and other types of pages or modules. The user 105 may then customize the module by filling out a form (e.g., which includes text boxes, radio buttons, or other input elements) on a customization interface and/or uploading multimedia data to populate the contents of the module via the customization interface.

As mentioned above, the application builder 150 may be configured to assist a user 105 in distributing an application 160 to a target device 170 and/or an application marketplace that permits individuals to download or purchase applications 160. In certain embodiments, an application marketplace may be provided by the app building server 140 that was utilized to create and/or update the application. In other embodiments, the application marketplace may be provided by a server which is located remotely or externally from the app building server 140.

Moving on, FIG. 5 illustrates an exemplary method 500 for creating or updating an application 160 (or portion thereof) using content of a pre-existing application 135 in accordance with certain embodiments. A user 105 may select an option for creating or updating an application using content of a pre-existing application 135 (step 510). For example, a user 105 may select a button or link that permits the user 105 to create a new application using the content of one or more pre-existing applications 135 (e.g., similar to the second option 302 in FIG. 3A), or to supplement an application with the content from one or more pre-existing applications 135 (e.g., similar to the third option 303 in FIG. 3A). In certain embodiments, the interface providing the options may be provided to the user over a network 190 from an app building server 140. In other embodiments, the options may be provided on an interface of an application running on a personal computing device 110.

One or more pre-existing applications 135 may be identified for use in creating or updating an application 160 (step 520). For example, a user 105 may specify one or more network addresses (e.g., IP addresses or URLs) that identify the locations of pre-existing applications 135. A user 105 may also upload copies of pre-existing applications 135 to an app building server 140 that hosts an application builder 150 or otherwise make the pre-existing applications 135 available to the application builder 150.

The content of the identified pre-existing applications 135 is analyzed in accordance with a rule set 210 to detect application features associated with the pre-existing applications 135 (step 530). In certain embodiments, this may be performed by the application analyzer 220 described above. The application content that is analyzed may include multimedia data, source code and tags, metadata files, manifest files, data included an application package, and/or any other data that may be useful in detecting application features. Based on the analysis of the application content, one or more application features may be detected.

The application features that are detected by analyzing the application content may encompass nearly any feature that can be displayed on an interface of a pre-existing application 135 or may otherwise be provided by a pre-existing application 135. For example, the application features may include multimedia data (e.g., text, images, video and audio recordings) that is displayed by a pre-existing application 135 or data related to application permissions. The detected application features may also include menus, application icons, application permissions, input forms, photo galleries, shopping carts, event calendars, RSS feeds, message boards, product listings, hyperlinks (including social media links associated with social networking or social media sites such as Facebook™, Twitter™ or LinkedIn™), titles for interfaces, headings on interfaces, blogs, contact lists, or other types of application features. The application features may further include data that is accessible to a pre-existing application 135 (e.g., data made available by other applications or by an operating system associated with a target device 170), external software functions that may be utilized by the application and hardware components that may be utilized to the application.

The detected application features of the identified pre-existing applications may then be incorporated into application modules for the application 160 that is being created or updated (step 540). One or more conversion templates 230 may be utilized to incorporate the application features into the application 160. In certain embodiments, separate application modules may be constructed for one or more interfaces that are provided by an identified pre-existing application 135. The application module created for a particular interface may be customized to incorporate the multimedia data included on the interface, along with any other application feature (e.g., input forms, hyperlinks and photo galleries) that is included on the interface.

In certain embodiments, to facilitate the construction of the application modules, preassembled modules may be populated with multimedia content from a pre-existing application 135. For example, a module for a photo gallery may be populated with images extracted from a pre-existing application 135 if a photo gallery was detected within the content of the pre-existing application 135, or a module for an event calendar may be populated with event data (e.g., event name, event date and time of event) extracted from the content of the pre-existing application 135 if an event calendar was detected within the content of the pre-existing application 135. Other types of preassembled modules may also be utilized.

Once the application modules are derived from the content of the one or more pre-existing applications 135, the user 105 utilizing the application builder 150 to construct the application 160 may be provided with a set of tools 270 that permit the user 105 to edit the application modules, to supplement the application 160 with additional modules, and to delete application modules (step 550). As explained above, the tools 270 may permit the user 105 to edit the application modules associated with an application 160 in various ways. For example, the tools 270 may permit the user 105 to modify (e.g., add, delete or edit) multimedia data displayed on the interfaces associated with the application modules, and to supplement the interfaces to include nearly any type of application feature (e.g., input forms, calendars or RSS feeds).

While there have been shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

What is claimed is:

1. A system for creating or updating a software application using content from a pre-existing application, comprising:
a processor configured to:
provide an application development platform adapted to assist a user with developing a software application, the application development platform being configured to utilize content of a pre-existing application to create or update the software application;
receive an input from the user that identifies the pre-existing application to be utilized in creating or updating the software application;
analyze application content of the identified pre-existing application in accordance with a rule set to detect application features associated with the pre-existing application and to determine one or more application modules that are to be created or updated for the software application, wherein the rule set includes rules for detecting content features, functional features and design features; and
incorporate the detected application features into the one or more application modules for the software application.

2. The system of claim 1, wherein the received input comprises at least one of the following:
an input identifying a network address that specifies a location of the pre-existing application; or
an input associated with uploading the pre-existing application to the application development platform.

3. The system of claim 1, wherein analyzing the application content of the identified pre-existing application involves analyzing files included in an application package that comprises files and directories for the software application, and further includes at least one of:
analyzing data in one or more source code files included in the application package;
analyzing data in one or more metadata files included in the application package;
analyzing data in one or more manifest files included in the application package; or
analyzing markup tags associated with a web application.

4. The system of claim 1, wherein determining one or more application modules that are to be created or updated for the software application includes identifying a set of interfaces that are provided by the pre-existing application and associating application modules with the interfaces such that application features detected on the interfaces of the pre-existing application are incorporated into corresponding application modules for the software application.

5. The system of claim 1, wherein the processor is further configured to:
analyze the application content with the rule set to detect an application feature selected from the group consisting of:
multimedia data;
application permissions;
an input form;
a photo gallery;
a video gallery;
a blog;
a social media link;
a RSS feed;
an Atom feed;
an event calendar; and
a shopping cart.

6. The system of claim 1, wherein the processor is further configured to:
populate a preassembled module that has been created for the software application with multimedia data from the pre-existing application to incorporate at least one application feature into the preassembled module.

7. The system of claim 1, wherein the processor is further configured to:
provide tools configured to permit a user to customize the one or more application modules and the application features associated with the one or more application modules.

8. The system of claim 1, wherein the processor is further configured to:
determine an application type of the pre-existing application; and
select one of a plurality of rule sets based on the application type of the pre-existing application, the selected rule set including rules or policies for detecting application features in a pre-existing application having the determined application type.

9. The system of claim 1, wherein the processor is further configured to:
select a conversion template that includes rules or code for incorporating the detected application features into the software application based on an application type of the software application.

10. The system of claim 1, wherein the pre-existing application is a mobile application and the software application is embodied in a generic format that stores the application features associated with the software application in a uniform manner to facilitate conversion of the software application into another application having a different application type.

11. A method for creating or updating a software application using content from a pre-existing application, comprising:
providing an application development platform adapted to assist a user with developing a software application, the application development platform being configured to utilize content of a pre-existing application to create or update the software application;
receiving an input from the user that identifies the pre-existing application to be utilized in creating or updating the software application;
analyzing, with a processor, application content of the identified pre-existing application in accordance with a rule set to detect application features associated with the pre-existing application and to determine one or more application modules that are to be created or updated for the software application, wherein the rule set includes rules for detecting content features, functional features and design features; and
incorporating the detected application features into the one or more application modules for the software application.

12. The method of claim 11, wherein the received input comprises at least one of the following:
an input identifying a network address that specifies a location of the pre-existing application; or
an input associated with uploading the pre-existing application to the application development platform.

13. The method of claim 11, wherein analyzing the application content of the identified pre-existing application involves analyzing files included in an application package that comprises files and directories for the software application, and further includes at least one of:
analyzing data in one or more source code files included in the application package;
analyzing data in one or more metadata files included in the application package;
analyzing data in one or more manifest files included in the application package; or
analyzing markup tags associated with a web application.

14. The method of claim 11, wherein determining one or more application modules that are to be created or updated for the software application includes identifying a set of interfaces that are provided by the pre-existing application and associating application modules with the interfaces such that application features detected on the interfaces of the pre-existing application are incorporated into corresponding application modules for the software application.

15. The method of claim 11, further comprising:
analyzing the application content with the rule set to detect an application feature selected from the group consisting of:
multimedia data;
application permissions;
an input form;
a photo gallery;
a video gallery;
a blog;
a social media link;
a RSS feed;
an Atom feed;
an event calendar; and
a shopping cart.

16. The method of claim 11, further comprising:
populating a preassembled module that has been created for the software application with multimedia data from the pre-existing application to incorporate at least one application feature into the preassembled module.

17. The method of claim 11, further comprising:
providing tools configured to permit a user to customize the one or more application modules and the application features associated with the one or more application modules.

18. The method of claim 11, further comprising:
determining an application type of the pre-existing application; and
selecting one of a plurality of rule sets based on the application type of the pre-existing application, the selected rule set including rules or policies for detecting application features in a pre-existing application having the determined application type.

19. The method of claim 11, further comprising:
selecting a conversion template that includes rules or code for incorporating the detected application features into the software application based on an application type of the software application.

20. The method of claim 11, wherein the pre-existing application is a mobile application and the software application is embodied in a generic format that stores the application features associated with the software application in a uniform manner to facilitate conversion of the software application into another application having a different application type.

21. A non-transitory computer storage medium comprising program instructions for creating or updating a software application using content of a pre-existing application, wherein the program instructions, when executed on a computer, cause the computer to:
provide an application development platform adapted to assist a user with developing a software application, the application development platform being configured to utilize content of a pre-existing application to create or update a software application;
receive an input from the user that identifies the pre-existing application to be utilized in creating or updating the software application;
analyze application content of the identified pre-existing application in accordance with a rule set to detect application features associated with the pre-existing application and to determine one or more application modules that are to be created or updated for the software application, wherein the rule set includes rules for detecting content features, functional features and design features; and
incorporate the detected application features into the one or more application modules for the software application.

22. The computer storage medium of claim 21, wherein the received input comprises at least one of the following:
an input identifying a network address that specifies a location of the pre-existing application; or
an input associated with uploading the pre-existing application to the application development platform.

23. The computer storage medium of claim 21, wherein analyzing the application content of the identified pre-existing application involves analyzing files included in an application package that comprises files and directories for the software application, and further includes at least one of:
analyzing data in one or more source code files included in the application package;
analyzing data in one or more metadata files included in the application package;
analyzing data in one or more manifest files included in the application package; or
analyzing markup tags associated with a web application.

24. The computer storage medium of claim 21, wherein determining one or more application modules that are to be created or updated for the software application includes identifying a set of interfaces that are provided by the pre-existing application and associating application modules with the interfaces such that application features detected on the interfaces of the pre-existing application are incorporated into corresponding application modules for the software application.

25. The computer storage medium of claim 21, wherein the program instructions further cause the computer to:
analyze the application content with the rule set to detect an application feature selected from the group consisting of:
multimedia data;
application permissions;
an input form;
a photo gallery;
a video gallery;
a blog;
a social media link;
a RSS feed;
an Atom feed;
an event calendar; and
a shopping cart.

26. The computer storage medium of claim 21, wherein the program instructions further cause the computer to:
populate a preassembled module that has been created for the software application with multimedia data from the pre-existing application to incorporate at least one application feature into the preassembled module.

27. The computer storage medium of claim 21, wherein the program instructions further cause the computer to:
provide tools configured to permit a user to customize the one or more application modules and the application features associated with the one or more application modules.

28. The computer storage medium of claim 21, wherein the program instructions further cause the computer to:
determine an application type of the pre-existing application; and
select one of a plurality of rule sets based on the application type of the pre-existing application, the selected rule set including rules or policies for detecting application features in a pre-existing application having the determined application type.

29. The computer storage medium of claim 21, wherein the program instructions further cause the computer to:
select a conversion template that includes rules or code for incorporating the detected application features into the software application based on an application type of the software application.

30. The computer storage medium of claim 21, wherein the pre-existing application is a mobile application and the software application is embodied in a generic format that stores the application features associated with the software application in a uniform manner to facilitate conversion of the software application into another application having a different application type.
